(19) United States
(12) Patent Application Publication
(10) Pub. No.: US 2023/0408767 A1
(43) Pub. Date: Dec. 21, 2023

(54) High-Temperature-Compatible Fiber Array Packaging Methods

(71) Applicant: Ayar Labs, Inc., Santa Clara, CA (US)

(72) Inventors: Derek M. Kita, Santa Clara, CA (US); Chong Zhang, San Jose, CA (US); John Fini, Albany, CA (US); Li-Fan Yang, Santa Clara, CA (US)

(21) Appl. No.: 18/335,088

(22) Filed: Jun. 14, 2023

Related U.S. Application Data
(60) Provisional application No. 63/353,492, filed on Jun. 17, 2022.

(51) Int. Cl. G02B 6/30

(52) U.S. Cl. CPC G02B 6/305

(57) ABSTRACT

A package assembly includes a photonic integrated circuit chip that includes an optical fiber attachment area. The package assembly also includes at least one optical fiber positioned within the optical fiber attachment area. The package assembly also includes a lid structure disposed over the at least one optical fiber. The package assembly also includes a plurality of soldered connections that secure the lid structure to the photonic integrated circuit chip. The plurality of soldered connections are configured to draw the lid structure toward the photonic integrated circuit chip so as to press the lid structure against the at least one optical fiber to mechanically hold the at least one optical fiber against the optical fiber attachment area. The package assembly also includes a package component to which the photonic integrated circuit chip is flip-chip attached after formation of the plurality of soldered connections.

### CROSS-REFERENCE TO RELATED APPLICATIONS

This claims priority under 35 U.S.C. 119(e) to U.S. Provisional Patent Application No. 63/353,492, filed on Jun. 17, 2022, the disclosure of which is incorporated herein by reference in its entirety for all purposes.

### BACKGROUND OF THE INVENTION

Optical data communication systems operate by modulating laser light to encode digital data patterns. The modulated laser light is transmitted through an optical data network from a sending node to a receiving node. The modulated laser light having arrived at the receiving node is de-modulated to obtain the original digital data patterns. The transmission of light through the optical data network includes transmission of light through optical fibers and transmission of light between optical fibers and photonic integrated circuits. Therefore, implementation and operation of optical data communication systems is dependent upon having reliable and efficient solutions for optically connecting optical fibers with photonic integrated circuits. It is within this context that the present disclosed embodiments arise.

### SUMMARY OF THE INVENTION

In an example embodiment, a package assembly is disclosed. The package assembly includes a photonic integrated circuit chip that includes an optical fiber attachment area. The package assembly also includes at least one optical fiber positioned within the optical fiber attachment area. The package assembly also includes a lid structure disposed over the at least one optical fiber. The package assembly also includes a plurality of soldered connections that secure the lid structure to the photonic integrated circuit chip. The plurality of soldered connections are configured to draw the lid structure toward the photonic integrated circuit chip so as to press the lid structure against the at least one optical fiber to mechanically hold the at least one optical fiber against the optical fiber attachment area of the photonic integrated circuit chip.

In an example embodiment, a method is disclosed for attaching an optical fiber to a photonic integrated circuit chip. The method includes having a photonic integrated circuit chip that includes an optical fiber attachment area. The method also includes disposing at least one optical fiber within the optical fiber attachment area. The method also includes disposing a lid structure over the at least one optical fiber. The method also includes forming soldered connections between the lid structure and the photonic integrated circuit chip, such that upon cooling of the soldered connections, the lid structure is drawn toward the photonic integrated circuit chip causing the lid structure to press against the at least one optical fiber to mechanically hold the at least one optical fiber against the optical fiber attachment area of the photonic integrated circuit chip.

In an example embodiment, a method is disclosed for manufacturing a package assembly. The method includes having a photonic integrated circuit chip that includes an optical fiber attachment area. The method also includes disposing at least one optical fiber within the optical fiber attachment area. The method also includes disposing a lid structure over the at least one optical fiber. The method also includes performing a first solder reflow process to form a first set of soldered connections between the lid structure and the photonic integrated circuit chip, such that upon cooling of the first set of soldered connections, the lid structure presses against the at least one optical fiber to mechanically hold the at least one optical fiber against the optical fiber attachment area of the photonic integrated circuit chip. The method also includes performing a second solder reflow process to form a second set of soldered connections between the photonic integrated circuit chip and a package component. The second solder reflow process is performed after forming the first set of soldered connections.

### BRIEF DESCRIPTION OF THE DRAWINGS

FIG. 1 shows a diagram of a fiber-to-chip/package assembly in which optical fibers are attached to a PIC chip by an adhesive.

FIG. 2A shows a vertical cross-sectional view of a package assembly in which optical fibers are attached to a PIC chip through use of a lid structure, in accordance with some embodiments.

FIG. 2B shows the vertical cross-sectional view of the package assembly of FIG. 2A, with the carrier component of FIG. 2A replaced by a carrier component that extends completely over the PIC chip, in accordance with some embodiments.

FIG. 2C shows the vertical cross-sectional view of the package assembly of FIG. 2A, with the glass fiber array block removed and with the carrier component of FIG. 2A replaced by another carrier component that attaches directly to the fiber array unit, in accordance with some embodiments.

FIG. 2D shows the vertical cross-sectional view of the package assembly of FIG. 2C, with the carrier component of FIG. 2C replaced by a carrier component that attaches directly to the fiber array unit and that extends completely over the PIC chip, in accordance with some embodiments.

FIG. 2E shows a side view of the PIC chip looking toward the optical fiber attachment area, in accordance with some embodiments.

FIG. 2F shows an example arrangement of the soldered connections in a bottom view of the PIC chip looking toward the optical fiber attachment area, in accordance with some embodiments.

FIG. 3 shows the beginning of an example process of forming the package assemblies as shown in FIGS. 2A-2F, in accordance with some embodiments.

FIG. 4 shows a continuation of the process from FIG. 3 in which the optical fibers are positioned in the optical fiber attachment area of the PIC chip, with the lid structure positioned over the optical fibers, in accordance with some embodiments.

FIG. 5 shows a continuation of the process from FIG. 4 in which a heat source is applied to the lid structure to cause reflow of the solder between the PIC chip and the lid structure, in accordance with some embodiments.

FIG. 6 shows a continuation of the process from FIG. 5 in which a heat source is removed from the lid structure at the end of the solder reflow process, in accordance with some embodiments.

FIG. 7 shows a continuation of the process from FIG. 6 after completion of the solder reflow process to attach the lid structure to the PIC chip, in accordance with some embodiments.

FIG. 8 shows a continuation of the process from FIG. 7 in which the bonding material is disposed to secure the glass fiber array block to the carrier component, in accordance with some embodiments.

FIG. 9 shows use of a test probe card to provide functional testing of the PIC chip and optical connections between the optical fibers and the PIC chip after the lid structure is secured to the PIC chip and before the PIC chip is flip-chip bonded to the package component, in accordance with some embodiments.

FIG. 10A shows a continuation of the process from FIG. 8, and optionally from the testing of FIG. 9, in which the PIC chip is flip-chip attached to the package component, in accordance with some embodiments.

FIG. 10B shows a continuation of the process from FIG. 10A after completion of the solder reflow process to attach the PIC chip to the package component, in accordance with some embodiments.

FIG. 11A shows a continuation of the process from FIG. 8, and optionally from the testing of FIG. 9, in which the carrier component in the assembly of FIG. 8 is replaced by the carrier component as shown in FIG. 2A, in accordance with some embodiments.

FIG. 11B shows a continuation of the process from FIG. 11A after completion of the solder reflow process to attach the PIC chip to the package component, in accordance with some embodiments.

FIG. 12 shows a flowchart of a method for attaching an optical fiber to a PIC chip, in accordance with some embodiments.

FIG. 13 shows a flowchart of a method for manufacturing a package assembly, in accordance with some embodiments.

### DETAILED DESCRIPTION OF THE INVENTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Various embodiments disclosed herein relate to optical data communication. Integrated photonic platforms have become increasingly attractive for a wide range of applications, such as sensing and optical data communications, which benefit from having multiple optical functionalities implemented within a photonic integrated circuit (PIC) semiconductor chip (PIC chip). In particular, silicon photonic platforms have emerged as a key technology because they allow for implementing both electrical and optical functionalities on a single substrate that can be manufactured using existing and mature complementary metal-oxide-semiconductor (CMOS) fabrication processes. Silicon photonics systems also include integrated optical waveguides with high refractive index contrast, which in turn enables tight bending radii and compact optical system footprints.

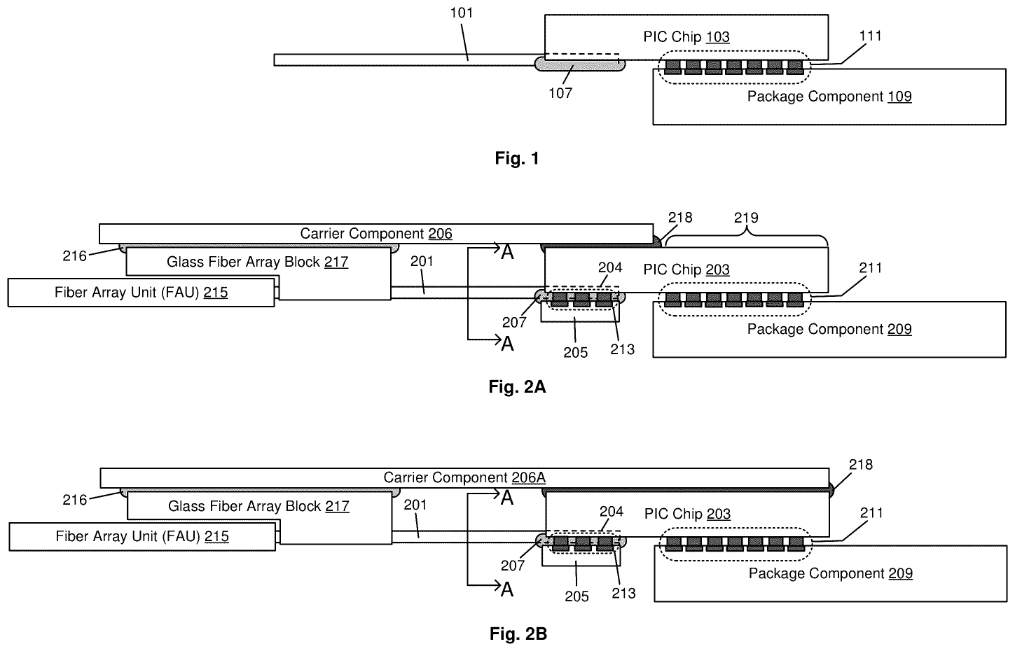

FIG. 1 shows a diagram of a fiber-to-chip/package assembly in which optical fibers 101 are attached to a PIC chip 103 by an adhesive 107. In some embodiments, the adhesive 107 is an epoxy. The PIC chip 103 is attached to a package component 109 by a number of solder ball connections 111, such as in a flip-chip attachment process. During the solder reflow process used to establish the solder ball connections 111 to attach the PIC chip 103 to the package component 109, the adhesive 107 is vulnerable to elastic and/or plastic deformation which can adversely affect optical alignment between the optical fibers 101 and the PIC chip 103.

In some embodiments, the optical fibers 101 are optically coupled to respective spot size converters, such as optical grating structures or other optical coupling devices, within a PIC chip 103. In some embodiments, the adhesive 107 is an ultraviolet (UV) or thermal curable adhesive, e.g., epoxy, among others, with a glass transition temperature (Tg) within a range extending from about 100° C. to about 200° C. In order for optical fibers 101 to be attached to the PIC chip 103 before the PIC chip 103 is flip-chip bonded to the package component 109, the PIC chip 103, package component 109, and optical fiber attachments (adhesive 107 attachments) have to be able to withstand normal solder reflow temperatures on the order of about 260° C. or higher. In some embodiments, for thermal compression bonding (TCB) or laser assisted bonding, the temperature of the optical fiber attachment area on the PIC chip 103 may be a bit lower than about 260° C. due to use of more localized heating. However, even in TCB or laser assisted bonding, there is still a chance that the temperature of the optical fiber attachment area on the PIC chip 103 will exceed the glass transition temperature (Tg) of the adhesive 107 that was previously used to attach the optical fibers 101 to the PIC chip 103. During the solder reflow process to flip-chip bond the PIC chip 103 to the package component 109, the adhesive 107 used to attach the optical fibers 101 to the PIC chip 103 (the adhesive 107 at the optical fiber 101-to-PIC chip 103 interface) can experience a reduction in mechanical modulus and corresponding elastic and/or plastic deformation, which can adversely impact the optical alignment between the optical fibers 101 and respective spot size converters on the PIC chip 103, and in turn cause corresponding degradation in the quality of the optical connections between the optical fibers 101 and the PIC chip 103, which results in a corresponding increase in optical signal loss as light is transmitted between the optical fibers 101 and the respective spot size converters on the PIC chip 103.

Various embodiments are disclosed herein for packaging of optical fibers with a PIC chip that enables reliable and sustainable optical fiber attachment to the PIC chip before the PIC chip is connected to a package component through a high-temperature attachment process, such as solder reflow, TCB, laser assisted bonding, or another high-temperature bonding process, e.g., flip-chip attachment process. It should be understood that the package component referred to herein can be essentially any type of semiconductor package component or assembly used in the semiconductor industry. Also, in various embodiments, the package component referenced herein can be an interposer, a field programmable gate array (FPGA), an application specific integrated circuit (ASIC), and/or another type of semiconductor chip or structure. Moreover, the optical fibers referred to herein can be any type of optical fiber, including single-mode optical fiber, multi-mode optical fiber, and special-purpose optical fiber, among essentially any other type of optical fiber.

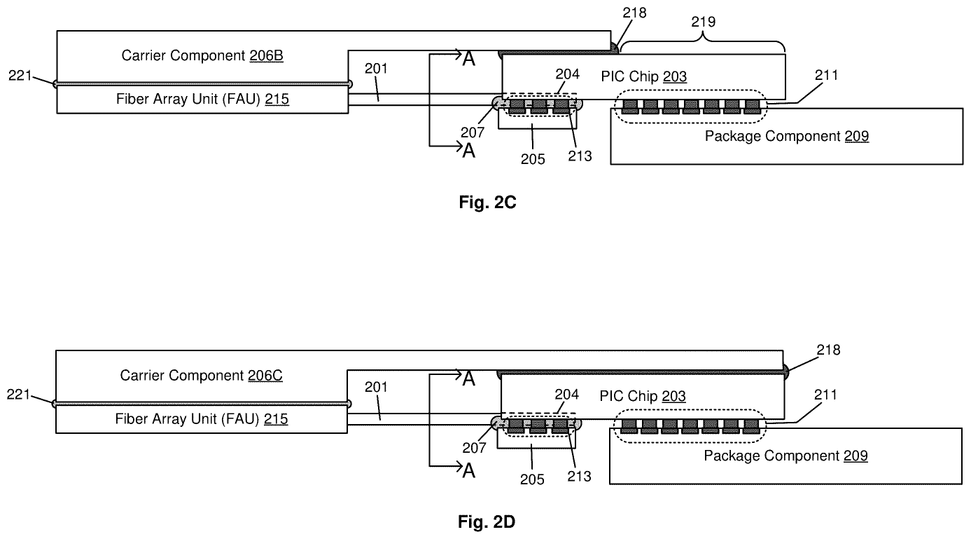

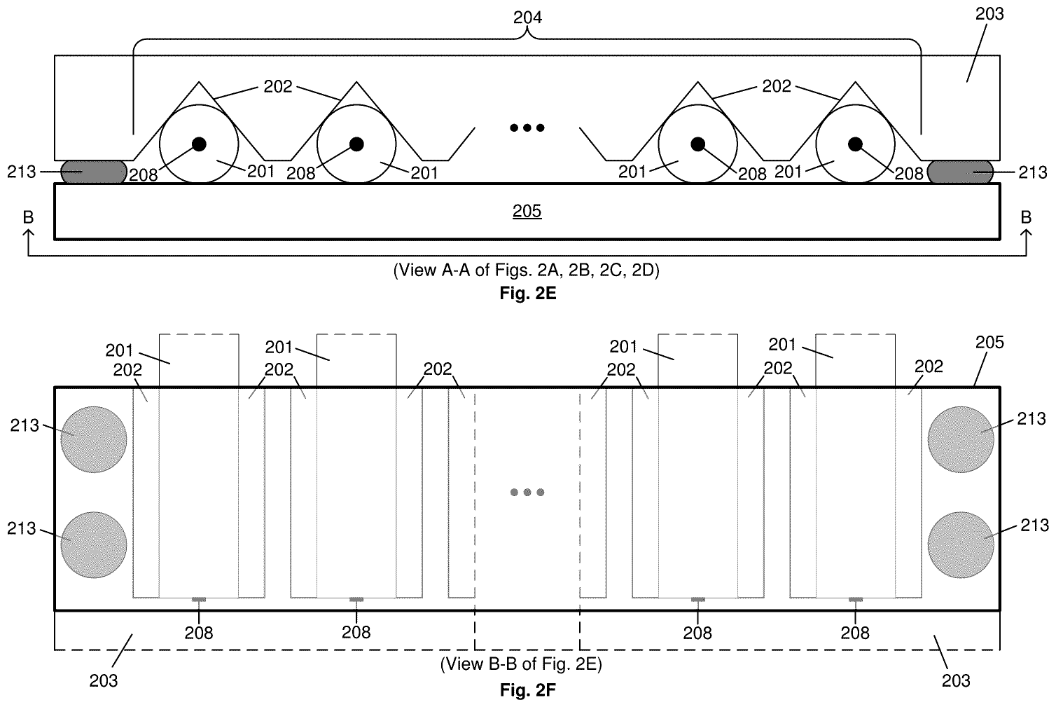

FIG. 2A shows a vertical cross-sectional view of a package assembly in which optical fibers 201 are attached to a PIC chip 203 through use of a lid structure 205, in accordance with some embodiments. The lid structure 205 is also referred to as a top lid structure. In some embodiments, the PIC chip 203 is a CMOS chip. In some embodiments, the PIC chip 203 is a SOI (silicon-on-insulator) chip. It should be understood that the PIC chip 203 is semiconductor chip that includes both electrical components and optical components. In some embodiments, the PIC chip is the TeraPHY™ chip provided by Ayar Labs, Inc, such as described in U.S. patent application Ser. No. 17/184,537, which is incorporated herein by reference in its entirety for all purposes. However, it should be understood that the PIC chip 203 referred to herein can be any type of photonic/electronic chip that is optically connected to external optical fibers 201 and that is electrically connected to a package component 209.

In some embodiments, each of the optical fibers 201 is optically coupled to a respective spot size converter, such as an optical grating structure or other optical coupling device, within the PIC chip 203. In some embodiments, the optical fibers 201 are included in an optical fiber array unit (FAU) 215. In some embodiments, the optical fibers 201 are included in an optical fiber ribbon. Also, in some embodiments, the optical fibers 201 are fixed in a glass fiber array block 217 as they approach the PIC chip 203. The optical fibers 201 are attached to the PIC chip 203 within an optical fiber attachment area 204 formed on the PIC chip 203.

FIG. 2E shows a side view of the PIC chip 203 looking toward the optical fiber attachment area 204, in accordance with some embodiments. A number of V-grooves 202 are formed within the optical fiber attachment area 204 of the PIC chip 203 for respectively receiving the optical fibers 201. In some embodiments, the optical fibers 201 are aligned to respective V-grooves 202 formed within an optical fiber attachment area 204 on the PIC chip 203. In some embodiments, the V-grooves 202 within the optical fiber attachment area 204 are configured to provide for passive optical alignment of the cores of the optical fibers 201 to respective spot size converters 208 within the PIC chip 203 that are optically accessible at an exterior facet of the PIC chip 203. In some embodiments, the V-grooves 202 within the optical fiber attachment area 204 are configured to enable optical edge-coupling of the cores of the optical fibers 201 to the respective spot size converters 208 of the PIC chip 203. In some embodiments, the V-grooves 202 within the optical fiber attachment area 204 are configured to enable optical coupling of the cores of the optical fibers 201 to respective vertical optical grating couplers of the PIC chip 203.

The PIC chip 203 is attached to the package component 209 through a high-temperature bonding process, e.g., flip-chip attachment process. In various embodiments, the package component 209 is one or more of an interposer, an FPGA, an ASIC, or another type of semiconductor chip, semiconductor package or substrate structure used in the semiconductor industry. In some embodiments, the PIC chip 203 is attached to the package component 209 by a number of soldered connections 211. In various embodiments, the optical fibers 201 are attached within the optical fiber attachment area 204 of the PIC chip 203 before the PIC chip 203 is attached to the package component 209 through the high-temperature bonding process. In order to enable attachment of the optical fibers 201 to the PIC chip 203 before performing the high-temperature bonding process on the PIC chip 203, and avoid the above-mentioned problems caused by adhesive elastic and/or plastic deformation around the optical fibers 201, the lid structure 205 is disposed to securely hold the optical fibers 201 within the optical fiber attachment area 204 of the PIC chip 203. Specifically, the lid structure 205 is disposed over the optical fibers 201 within the optical fiber attachment area 204 of the PIC chip 203, such that the lid structure 205 applies a mechanical force to the optical fibers 201 to securely hold the optical fibers 201 within the optical fiber attachment area 204, e.g., within the V-grooves 202, of the PIC chip 203 and to maintain optical alignment of the cores of the optical fibers 201 with the respective spot size converters 208 exposed at the exterior facet surface of the PIC chip 203. It should be understood that the optical fibers 201 are optically aligned with corresponding spot size converters 208, e.g., optical grating structures or similar optical port devices, within the PIC chip 203 when the optical fibers 201 are secured between the lid structure 205 and the PIC chip 203.

In some embodiments, the lid structure 205 is a formed of silicon. Also, in some embodiments, the lid structure 205 is configured as a plate. In various embodiments, the lid structure 205 is configured to contact each of the optical fibers 101 is a substantially similar manner, such as with regard to contact area and contact force. The lid structure 205 is attached directly to the PIC chip 203 through an arrangement of soldered connections 213. When the solder that attaches the lid structure 205 to the PIC chip 203 cools and contracts, the lid structure 205 is drawn toward the PIC chip 203, which correspondingly causes the lid structure 205 to apply a mechanical force to the optical fibers 201 so as to press the optical fibers 201 against the optical fiber attachment area 204 of the PIC chip 203, e.g., into the V-grooves 202. In this manner, the lid structure 205 firmly holds the optical fibers 201 in place within the fiber attachment area 204 of the PIC chip 203 even during the subsequent performance of the high-temperature bonding process to attached the PIC chip 203 to the package component 209. It should be understood that the optical fibers 201 are positioned between the lid structure 205 and the PIC chip 203, such that optical fibers 201 are pressed against the PIC chip 203 by the lid structure 205 when the lid structure 205 is soldered to the PIC chip 203. The soldered connections 213 between the lid structure 205 and the PIC chip 203 are able to withstand the high-temperatures during the subsequent flip-chip bonding of the PIC chip 203 to the package component 209. In some embodiments, the soldered connections 213 used to attach the lid structure 205 to the PIC chip 203 are formed using an Au80-Sn20 solder material having a melting point of about 300° C. In some embodiments, the soldered connections 213 used to attach the lid structure 205 to the PIC chip 203 are formed using a tin-silver-copper (SAC) solder material that reflows at a temperature of about 260° C., particularly when TCB or laser assisted bonding is used for flip-chip attachment of the PIC chip 203 to the package component 209.

FIG. 2F shows an example arrangement of the soldered connections 213 in a bottom view of the PIC chip 203 looking toward the optical fiber attachment area 204, in accordance with some embodiments. It should be understood that the arrangement of the soldered connections 213 shown in FIG. 2F is provided by way of example to describe the principle of using the soldered attachment of the lid structure 205 to the PIC chip 203 to mechanically secure the optical fibers 201 within the optical fiber attachment area 204 of the PIC chip 203. It should be understood that in various other embodiments, the number and locations of the soldered connections 213 used to secure the lid structure 205 to the PIC chip 203 can vary from the example shown in FIG. 2F, so long as the lid structure 205 applies a sufficient mechanical force to each of the optical fibers 201, upon cooling and shrinkage of the soldered connections 213, to securely hold the optical fibers 201 in place within the optical fiber attachment area 204 of the PIC chip 203.

In some embodiments, an optical index-matched underfill adhesive 207, e.g., optical epoxy, is disposed within interstitial spaces present between the lid structure 205 and the PIC chip 203, and around the optical fibers 201 within the optical fiber attachment area 204 of the PIC chip 203. In some embodiments, the optical index-matched underfill adhesive 207 is a UV or thermal curable adhesive, e.g., optical epoxy, that has a glass transition temperature (Tg) within a range extending from about 100° C. to about 200° C. In some embodiments, the optical index of refraction of the optical index-matched underfill adhesive 207 substantially matches the optical index of refraction of the cores of the optical fibers 201 and of the spot size converters 208 at the exposed facet of the PIC chip 203 within the optical fiber attachment area 204, which benefits optical performance. Also, in some embodiments, the optical index-matched underfill adhesive 207 disposed within the interstitial spaces present between the lid structure 205 and the PIC chip 203 assists with mechanically securing the optical fibers 201 to the PIC chip 203.

In some embodiments, a carrier component 206 is disposed to assist with support of the optical fibers 201 in a fixed spatial relationship relative to the PIC chip 203 to which the optical fibers 201 are connected. In some embodiments, the carrier component 206 is formed of silicon. In some embodiments, the carrier component 206 is formed of a metal or metallic alloy, such as aluminum or stainless steel, among others. In some embodiments, the carrier component 206 is secured to the PIC chip 203 by a thermally conductive attachment material 218. In various embodiments, the thermally conductive attachment material 218 is one or more of solder/solder paste, thermally conductive epoxy, or another thermally conductive attachment material. In some embodiments, the carrier component 206 is formed as a plate structure or planar substrate structure. The carrier component 206 provides both mechanical stress relief for the optical fibers 201 and a platform for the PIC chip 203 during attachment of the optical fibers 201 to the PIC chip 203. In some embodiments, both the lid structure 205 and the carrier component 206 are used. However, in some embodiments, the lid structure 205 is used without use of the carrier component 206. In some embodiments, such as shown in FIGS. 2A and 2B, the carrier component 206 is disposed in connection with both the PIC chip 203 and the glass fiber array block 217. In some embodiments, a bonding material 216, e.g., epoxy, is used to attach the carrier component 206 to the glass fiber array block 217. In the example embodiment of FIG. 2A, the carrier component 206 is configured and attached to the PIC chip 203 so as to leave a portion 219 of the PIC chip 203 exposed. The portion 219 of the PIC chip 203 is sized to provide for thermal contact between a heat source and the portion 219 of the PIC chip 203 during the subsequent high-temperature bonding process, e.g., reflow process, for securing the PIC chip 203 to a package component 209.

FIG. 2B shows the vertical cross-sectional view of the package assembly of FIG. 2A, with the carrier component 206 of FIG. 2A replaced by a carrier component 206A that extends completely over the PIC chip 203, in accordance with some embodiments. In some embodiments, the carrier component 206A is formed of silicon. In some embodiments, the carrier component 206A is formed of a metal or metallic alloy, such as aluminum or stainless steel, among others. In some embodiments, the carrier component 206A is secured to the PIC chip 203 by the thermally conductive attachment material 218.

FIG. 2C shows the vertical cross-sectional view of the package assembly of FIG. 2A, with the glass fiber array block 217 removed and with the carrier component 206 of FIG. 2A replaced by a carrier component 206B that attaches directly to the FAU 215, in accordance with some embodiments. The carrier component 206B is shaped to attached to both the PIC chip 203 and the FAU 215. In some embodiments, the carrier component 206B is formed of silicon. In some embodiments, the carrier component 206B is formed of a metal or metallic alloy, such as aluminum or stainless steel, among others. The carrier component 206B is configured and attached to the PIC chip 203 so as to leave the portion 219 of the PIC chip 203 exposed for application of the heat source during the subsequent high-temperature bonding process, e.g., reflow process, for securing the PIC chip 203 to a package component 209. In some embodiments, the carrier component 206B is secured to the PIC chip 203 by the thermally conductive attachment material 218. Also, in some embodiments, a bonding material 221, e.g., epoxy, is used to attach the carrier component 206B to the FAU 215.

FIG. 2D shows the vertical cross-sectional view of the package assembly of FIG. 2C, with the carrier component 206B of FIG. 2C replaced by a carrier component 206C that attaches directly to the FAU 215 and that extends completely over the PIC chip 203, in accordance with some embodiments. In some embodiments, the carrier component 206C is formed of silicon. In some embodiments, the carrier component 206C is formed of a metal or metallic alloy, such as aluminum or stainless steel, among others. In some embodiments, the carrier component 206C is secured to the PIC chip 203 by the thermally conductive attachment material 218.

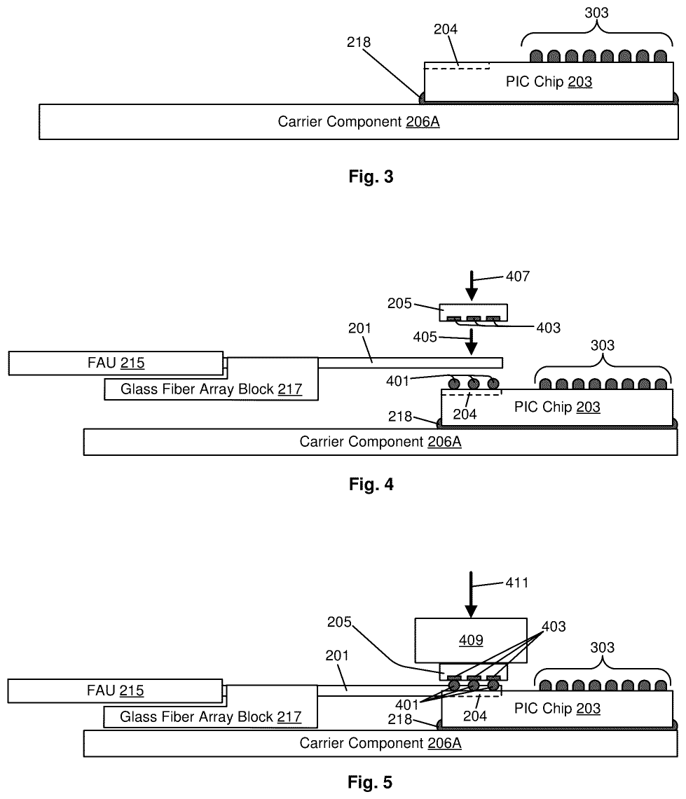

FIG. 3 shows the beginning of an example process of forming the package assemblies as shown in FIGS. 2A-2F, in accordance with some embodiments. The PIC chip 203 is secured to the carrier component 206A of FIG. 2B by way of the thermally conductive attachment material 218, with the optical fiber attachment area 204 of the PIC chip 203 facing away from the carrier component 206A. It should be understood that any of the other above-mentioned carrier components 206, 206B, and 206C may be used in place of the carrier component 206A in FIG. 3, as needed. In some embodiments, copper pillar bumps 303 are disposed on the PIC chip 203 to enable subsequent flip-chip attachment of the PIC chip 203 to the package component 209.

FIG. 4 shows a continuation of the process from FIG. 3 in which the optical fibers 201 are positioned in the optical fiber attachment area 204 of the PIC chip 203, with the lid structure 205 positioned over the optical fibers 201, in accordance with some embodiments. In various embodiments, solder 401, e.g., solder balls or solder paste, is applied to conductive pads disposed on the PIC chip 203 and/or conductive pads 403 on the lid structure 205 to facilitate soldering of the lid structure 205 to the PIC chip 203. In some embodiments, the solder 401 for attachment of the lid structure 205 to the PIC chip 203 is disposed on the PIC chip 203 when the copper pillar bumps 303 are disposed on the PIC chip 203, such as shown in FIG. 3. In some embodiments, the optical fibers 201 are respectively positioned within the V-grooves 202 formed within the optical fiber attachment area 204 of the PIC chip 203, as indicated by arrow 405. In some embodiments, the V-grooves 202 provide for passive alignment of the cores of the optical fibers 201 to the respective spot size converters 208 of the PIC chip 203. Once the optical fibers 201 are positioned within the V-grooves 202, the lid structure 205 is positioned over the optical fibers 201, as indicated by arrow 407, in preparation for soldering of the lid structure 205 to the PIC chip 203. In some embodiments, the lid structure 205 is positioned in physical contact with the optical fibers 201 prior to soldering of the lid structure 205 to the PIC chip 203. However, in some embodiments, a size of the solder 401 may cause a small gap to exist between the lid structure 205 and the optical fibers 201 prior to soldering of the lid structure 205 to the PIC chip 203.

FIG. 5 shows a continuation of the process from FIG. 4 in which a heat source 409 is applied to the lid structure 205, as indicated by arrow 411, to cause reflow of the solder 401, in accordance with some embodiments. In various embodiments, the heat source 409 is a thermal head, a hot plate, or a similar type of heating device that is configured to apply heat directly to the lid structure 205 to cause reflow of the solder 401 used to form the soldered connections 213 between the lid structure 205 and the PIC chip 203. In some embodiments, TCB and/or laser assisted bonding is used to reflow the solder 401 to form the soldered connections 213 between the lid structure 205 and the PIC chip 203, either in lieu of the heat source 409 or in combination with the heat source 409.

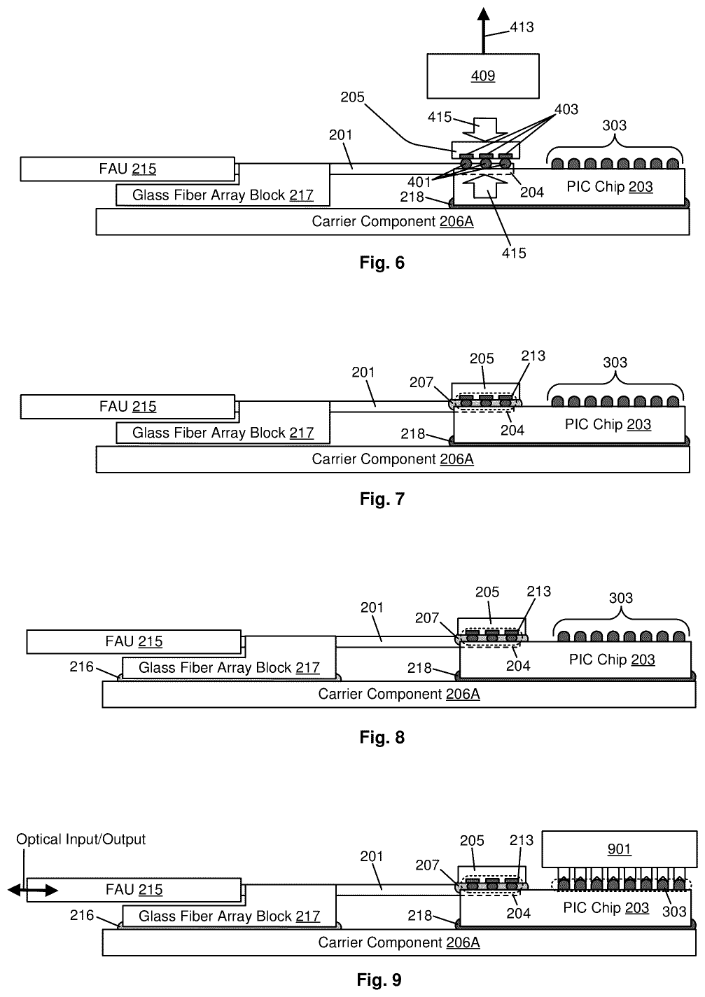

FIG. 6 shows a continuation of the process from FIG. 5 in which the heat source 409 is removed from the lid structure 205 at the end of the solder reflow process, as indicated by arrow 413, in accordance with some embodiments. When the heat source 409 is removed from the lid structure 205, the solder 401 between the lid structure 205 and the PIC chip 203 cools and correspondingly shrinks to form the soldered connections 213. This shrinkage of the solder 401 between the lid structure 205 and the PIC chip 203 causes the lid structure 205 to press the optical fibers 201 into the V-grooves 202, as indicated by the arrows 415, such that the lid structure 205 securely holds the optical fibers 201 in the V-grooves 202. In this manner, the optical fibers 201 are held in place through friction with both the lid structure 205 and the PIC chip 203 V-grooves 202, so as to provide a “press-fit” attachment of the optical fibers 201 to the PIC chip 203.

FIG. 7 shows a continuation of the process from FIG. 6 after completion of the solder reflow process to attach the lid structure 205 to the PIC chip 203, in accordance with some embodiments. FIG. 7 also shows the optical index-matched underfill adhesive 207 disposed within interstitial spaces present between the lid structure 205 and the PIC chip 203 and around the optical fibers 201.

FIG. 8 shows a continuation of the process from FIG. 7 in which the bonding material 216 is disposed to secure the glass fiber array block 217 to the carrier component 206A, in accordance with some embodiments. In various embodiments, the bonding material 216 can be disposed between the glass fiber array block 217 and the carrier component 206A either before, concurrent with, or after the optical index-matched underfill adhesive 207 is disposed between the lid structure 205 and the PIC chip 203. Also, in other embodiments in which the carrier component 206 is used instead of the carrier component 206A, the bonding material 216 is disposed between the glass fiber array block 217 and the carrier component 206, as shown in FIG. 2A. Also, in other embodiments in which the carrier component 206B is used instead of the carrier component 206A, the bonding material 216 is disposed between the carrier component 206A and the FAU 215, as shown in FIG. 2C. Also, in other embodiments in which the carrier component 206C is used instead of the carrier component 206A, the bonding material 216 is disposed between the carrier component 206C and the FAU 215, as shown in FIG. 2D.

FIG. 9 shows use of a test probe card 901 to provide functional testing of the PIC chip 203 and optical connections between the optical fibers 201 and the PIC chip 203 after the lid structure 205 is secured to the PIC chip 203 and before the PIC chip 203 is flip-chip bonded to the package component 209, in accordance with some embodiments. In some embodiments, a precise socket is used to facilitate alignment and electrical connection of the test probe card 901 to the copper pillar bumps 303 of the PIC chip 203. In some embodiments, the test probe card 901 includes probes that are configured to electrically contact respective ones of the copper pillar bumps 303 of the PIC chip 203. In this manner, the optical connectivity of the PIC chip 203 to the optical fibers 201 can be verified and optionally optimized before attachment of the PIC chip 203 to the package component 209. Also, in this manner, optical and electrical functionality of the PIC chip 203 can be tested and verified before attachment of the PIC chip 203 to the package component 209, which serves to prevent loss of a good package component 209 due to a faulty PIC chip 203.

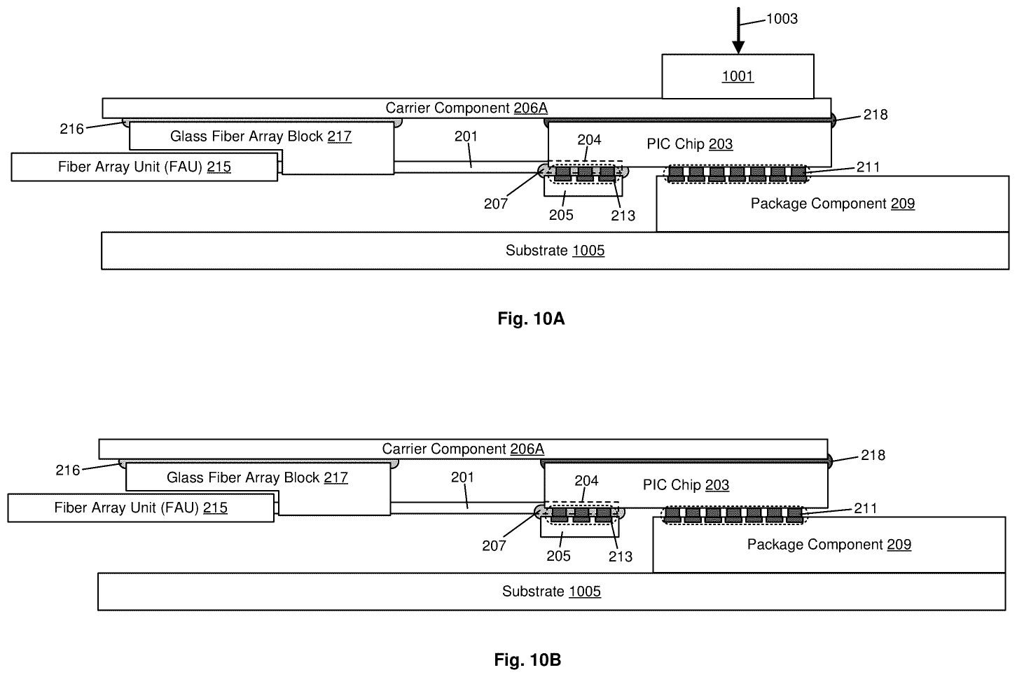

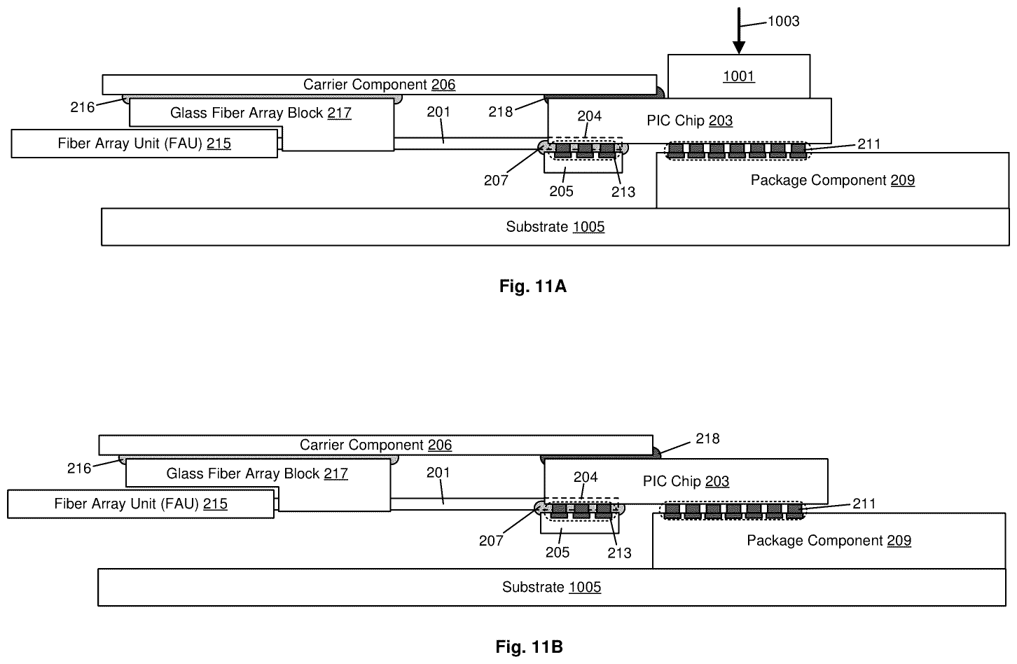

FIG. 10A shows a continuation of the process from FIG. 8, and optionally from the testing of FIG. 9, in which the PIC chip 203 is flip-chip attached to the package component 209, in accordance with some embodiments. A heat source 1001 is applied to the carrier structure 206A at a location directly over the copper pillar bumps 303 on the PIC chip 203, as indicated by arrow 1003. The heat output by the heat source 1001 is conducted through the carrier component and through the thermally conductive attachment material 218 and through the PIC chip 203 to cause reflow of the solder material that interfaces with the copper pillar bumps 303 of the PIC chip 203 and correspondingly form the soldered connections 211 between the PIC chip 203 and the package component 209. In various embodiments, the heat source 1001 is a thermal head, a hot plate, or a similar type of heating device that is configured to apply heat directly to the carrier component 206A to cause reflow of the solder material used to form the soldered connections 211 between the PIC chip 203 and the package component 209. In some embodiments, TCB and/or laser assisted bonding is used to reflow the solder material to form the soldered connections 211 between the PIC chip 203 and the package component 209, either in lieu of the heat source 1001 or in combination with the heat source 1001. In some embodiments, the carrier component 206A is replaced by the carrier component 206C, such as shown in FIG. 2D. In some embodiments, the solder material used to form the soldered connections 211 between the PIC chip 203 and the package component 209 has a reflow temperature that is lower than the solder material used to form the soldered connections 213 between the lid structure 205 and the PIC chip 203. In some embodiments, SAC solder material which reflows at a temperature of about 260° C. is used to connect each of the copper pillar bumps 303 of the PIC chip 203 to respective ones of multiple conductive pads on the package component 209. It should be understood, however, that in other embodiments, essentially any other suitable solder material can be used to attach the copper pillar bumps 303 of the PIC chip 203 to the conductive pads of the package component 209.

FIG. 10B shows a continuation of the process from FIG. 10A after completion of the solder reflow process to attach the PIC chip 203 to the package component 209, in accordance with some embodiments. The package assembly of FIG. 10B is essentially the same as the package assembly of FIG. 2B, with the additional optional attachment of the package component 209 to a substrate 1005.

FIG. 11A shows a continuation of the process from FIG. 8, and optionally from the testing of FIG. 9, in which the carrier component 206A in the assembly of FIG. 8 is replaced by the carrier component 206 as shown in FIG. 2A, in accordance with some embodiments. In this embodiment, carrier component 206 is configured to leave the portion 219 of the PIC chip 203 exposed. The heat source 1001 is applied directly to the exposed portion 219 of the PIC chip 203 at a location directly over the copper pillar bumps 303 on the PIC chip 203, as indicated by arrow 1003. The heat output by the heat source 1001 is conducted through the PIC chip 203 to cause reflow of the solder material that interfaces with the copper pillar bumps 303 of the PIC chip 203 and correspondingly form the soldered connections 211 between the PIC chip 203 and the package component 209. In some embodiments, the carrier component 206 is replaced by the carrier component 206B, such as shown in FIG. 2C.

FIG. 11B shows a continuation of the process from FIG. 11A after completion of the solder reflow process to attach the PIC chip 203 to the package component 209, in accordance with some embodiments. The package assembly of FIG. 11B is essentially the same as the package assembly of FIG. 2A, with the additional optional attachment of the package component 209 to the substrate 1005.

In accordance with the foregoing, various embodiments of a package assembly are disclosed herein. The package assembly includes the PIC chip 203 that includes the optical fiber attachment area 204. The package assembly also includes at least one optical fiber 201 positioned within the optical fiber attachment area 204. The package assembly also includes the lid structure 205 disposed over the at least one optical fiber 201. In some embodiments, the lid structure 205 is formed of silicon. The package assembly also includes a plurality of soldered connections 213 that secure the lid structure 205 to the PIC chip 203. In some embodiments, the plurality of soldered connections 213 are located around and outside of the optical fiber attachment area 204. The plurality of soldered connections 213 are configured to draw the lid structure 205 toward the PIC chip 203 so as to press the lid structure 205 against the at least one optical fiber 201 to mechanically hold the at least one optical fiber 201 against the optical fiber attachment area 204 of the PIC chip 203. In some embodiments, the plurality of soldered connections 213 are formed to shrink upon cooling after completion of a reflow process that forms the plurality of soldered connections 213. In some embodiments, one or both of the PIC chip 203 and the lid structure 205 include conductive pad structures 403 corresponding to the plurality of soldered connections 213. In some embodiments, the package assembly includes the package component 209, where the PIC chip 203 is flip-chip attached to the package component 209 after the plurality of soldered connections 213 are formed to secure the lid structure 205 to the PIC chip 203.

In some embodiments, the optical fiber attachment area 204 of the PIC chip 203 includes an array of a plurality of V-grooves 202. In these embodiments, the at least one optical fiber 201 is a plurality of optical fibers 201 respectively positioned within the plurality of V-grooves 202. In some embodiments, the PIC chip 203 includes a plurality of spot size converters 208. Each of the plurality of spot size converters 208 is exposed at an interior end (facet surface of the PIC chip 203) of a respective one of the plurality of V-grooves 202, wherein the interior end is interior with respect to an outer perimeter of the PIC chip 203. In these embodiments, each of the plurality of optical fibers 201 has a core optically aligned with a respective one of the plurality of spot size converters 208.

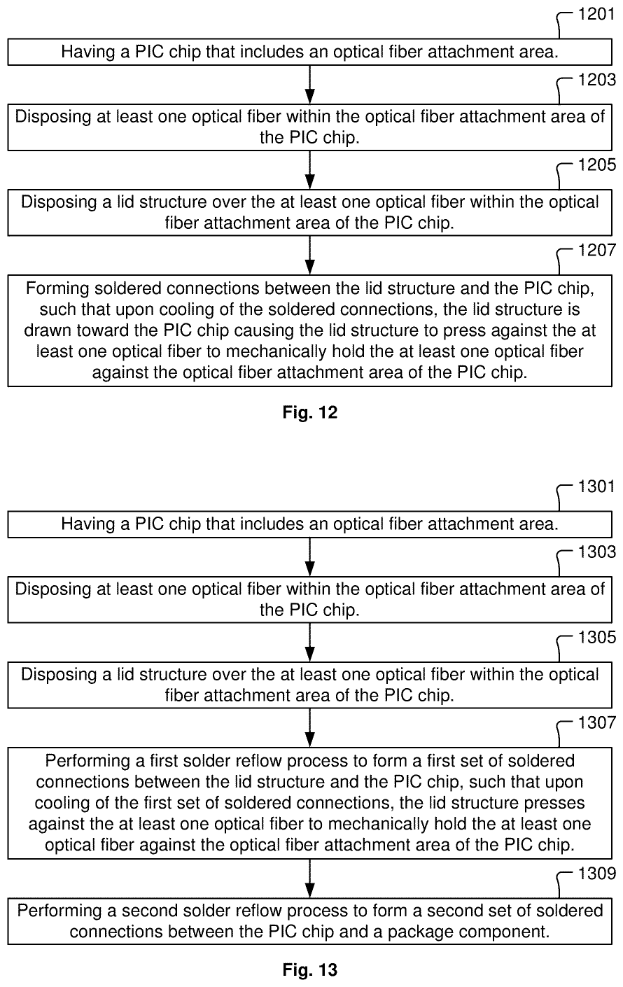

FIG. 12 shows a flowchart of a method for attaching the optical fiber 201 to the PIC chip 203, in accordance with some embodiments. The method includes an operation 1201 for having the PIC chip 203 that includes the optical fiber attachment area 204. The method also includes an operation 1203 for disposing at least one optical fiber 201 within the optical fiber attachment area 204. The method also includes an operation 1205 for disposing the lid structure 205 over the at least one optical fiber 201. In some embodiments, the lid structure 205 is formed of silicon. The method also includes an operation 1207 for forming the soldered connections 213 between the lid structure 205 and the PIC chip 203, such that upon cooling of the soldered connections 213, the lid structure 205 is drawn toward the PIC chip 203 causing the lid structure 205 to press against the at least one optical fiber 201 to mechanically hold the at least one optical fiber 201 against the optical fiber attachment area 204. In some embodiments, the soldered connections 213 are formed at locations around and outside of the optical fiber attachment area 204. In some embodiments, the operation 1207 includes performing a high-temperature solder reflow process. In some embodiments, the operation 1207 includes disposing solder balls 401 on the PIC chip 203 and respectively aligning conductive pad structures 403 within the lid structure 205 to the solder balls 401.

In some embodiments of the method of FIG. 12, the optical fiber attachment area 204 includes an array of a plurality of V-grooves 202. In these embodiments, the operation 1203 includes respectively disposing a plurality of optical fibers 201 within the plurality of V-grooves 202. Also, in these embodiments, the PIC chip 203 includes a plurality of spot size converters 208, where each of the plurality of spot size converters 208 is exposed at an interior end of a respective one of the plurality of V-grooves 202. In these embodiments, the method includes optically aligning a core of each of the plurality of optical fibers 201 with a respective one of the plurality of spot size converters 208 before performing the operation 1207 to form the soldered connections 213 between the lid structure 205 and the PIC chip 203. Additionally, in some embodiments, the method includes flip-chip attaching the PIC chip 203 to the package component 209 after the plurality of soldered connections 213 are formed to secure the lid structure 205 to the PIC chip 203, such that the flip-chip attaching does not disturb the soldered connections 213 between the lid structure 205 and the PIC chip 203.

FIG. 13 shows a flowchart of a method for manufacturing a package assembly, in accordance with some embodiments. The method includes an operation 1301 for having the PIC chip 203 that includes the optical fiber attachment area 204. The method also includes an operation 1303 for disposing at least one optical fiber 201 within the optical fiber attachment area 204. The method also includes an operation 1305 for disposing the lid structure 205 over the at least one optical fiber 201. The method also includes an operation 1307 for performing a first solder reflow process to form a first set of soldered connections 213 between the lid structure 205 and the PIC chip 203, such that upon cooling of the first set of soldered connections 213 the lid structure 205 presses against the at least one optical fiber 201 to mechanically hold the at least one optical fiber 201 against the optical fiber attachment area 204. The method also includes an operation 1309 that is performed after the operation 1307 (after forming the first set of soldered connections 213). The operation 1309 includes performing a second solder reflow process to form a second set of soldered connections 211 between the PIC chip 203 and the package component 209. In some embodiments, the second solder reflow process of operation 1309 is performed to avoid disturbance of the first set of soldered connections 213, so as to maintain mechanical hold of the at least one optical fiber 201 against the optical fiber attachment area 204 by the lid structure 205. In some embodiments, the method also includes an operation for attaching the carrier component 206, 206A, 206B, 206C to a surface of the PIC chip 203 opposite of the optical fiber attachment area 204. In these embodiments, the carrier component 206, 206A, 206B, 206C is attached either to the fiber array unit 215 that includes the at least one optical fiber 201 or to the glass fiber array block 217.

In some embodiments of the method of FIG. 13, the optical fiber attachment area 204 includes an array of the plurality of V-grooves 202, and the PIC chip 203 includes a plurality of spot size converters 208. Each of the plurality of spot size converters 208 is exposed at an interior end of a respective one of the plurality of V-grooves 202. In these embodiments, the operation 1303 for disposing the at least one optical fiber 201 within the optical fiber attachment area 204 includes respectively disposing a plurality of optical fibers 201 within the plurality of V-grooves 202. Also, in these embodiments, the method further includes optically aligning a core of each of the plurality of optical fibers 201 with a respective one of the plurality of spot size converters 208 before performing the first solder reflow process in the operation 1307 to form the first set of soldered connections 213 between the lid structure 205 and the PIC chip 203.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. A package assembly, comprising:
a photonic integrated circuit chip including an optical fiber attachment area;
at least one optical fiber positioned within the optical fiber attachment area;
a lid structure disposed over the at least one optical fiber; and
a plurality of soldered connections that secure the lid structure to the photonic integrated circuit chip, the plurality of soldered connections configured to draw the lid structure toward the photonic integrated circuit chip so as to press the lid structure against the at least one optical fiber to mechanically hold the at least one optical fiber against the optical fiber attachment area.

2. The package assembly as recited in claim 1, wherein the lid structure is formed of silicon.

3. The package assembly as recited in claim 1, wherein the plurality of soldered connections are located around and outside of the optical fiber attachment area.

4. The package assembly as recited in claim 1, wherein the plurality of soldered connections are formed to shrink upon cooling after completion of a reflow process that forms the plurality of soldered connections.

5. The package assembly as recited in claim 1, wherein one or both of the photonic integrated circuit chip and the lid structure include conductive pad structures corresponding to the plurality of soldered connections.

6. The package assembly as recited in claim 1, wherein the optical fiber attachment area includes an array of a plurality of V-grooves, and wherein the at least one optical fiber is a plurality of optical fibers respectively positioned within the plurality of V-grooves.

7. The package assembly as recited in claim 6, wherein the photonic integrated circuit chip includes a plurality of spot size converters, each of the plurality of spot size converters exposed at an interior end of a respective one of the plurality of V-grooves, wherein each of the plurality of optical fibers has a core optically aligned with a respective one of the plurality of spot size converters.

8. The package assembly as recited in claim 1, further comprising:
a package component, the photonic integrated circuit chip flip-chip attached to the package component after the plurality of soldered connections are formed to secure the lid structure to the photonic integrated circuit chip.

9. A method for attaching an optical fiber to a photonic integrated circuit chip, comprising:
having a photonic integrated circuit chip that includes an optical fiber attachment area;
disposing at least one optical fiber within the optical fiber attachment area;
disposing a lid structure over the at least one optical fiber; and
forming soldered connections between the lid structure and the photonic integrated circuit chip such that upon cooling of the soldered connections the lid structure is drawn toward the photonic integrated circuit chip causing the lid structure to press against the at least one optical fiber to mechanically hold the at least one optical fiber against the optical fiber attachment area.

10. The method as recited in claim 9, wherein the lid structure is formed of silicon.

11. The method as recited in claim 9, wherein the soldered connections are formed at locations around and outside of the optical fiber attachment area.

12. The method as recited in claim 9, wherein forming the soldered connections includes performing a high-temperature solder reflow process.

13. The method as recited in claim 9, wherein forming the soldered connections includes disposing solder balls on the photonic integrated circuit chip and respectively aligning conductive pad structures within the lid structure to the solder balls.

14. The method as recited in claim 9, wherein the optical fiber attachment area includes an array of a plurality of V-grooves, and wherein disposing the at least one optical fiber within the optical fiber attachment area includes respectively disposing a plurality of optical fibers within the plurality of V-grooves.

15. The method as recited in claim 14, wherein the photonic integrated circuit chip includes a plurality of spot size converters, each of the plurality of spot size converters exposed at an interior end of a respective one of the plurality of V-grooves, wherein the method includes optically aligning a core of each of the plurality of optical fibers with a respective one of the plurality of spot size converters before forming the soldered connections between the lid structure and the photonic integrated circuit chip.

16. The method as recited in claim 9, further comprising:
flip-chip attaching the photonic integrated circuit chip to a package component after the plurality of soldered connections are formed to secure the lid structure to the photonic integrated circuit chip, such that the flip-chip attaching does not disturb the soldered connections between the lid structure and the photonic integrated circuit chip.

17. A method for manufacturing a package assembly, comprising:
having a photonic integrated circuit chip that includes an optical fiber attachment area;
disposing at least one optical fiber within the optical fiber attachment area;
disposing a lid structure over the at least one optical fiber;
performing a first solder reflow process to form a first set of soldered connections between the lid structure and the photonic integrated circuit chip such that upon cooling of the first set of soldered connections the lid structure presses against the at least one optical fiber to mechanically hold the at least one optical fiber against the optical fiber attachment area; and
after forming the first set of soldered connections, performing a second solder reflow process to form a second set of soldered connections between the photonic integrated circuit chip and a package component.

18. The method as recited in claim 17, wherein the second solder reflow process is performed to avoid disturbance of the first set of soldered connections so as to maintain mechanical hold of the at least one optical fiber against the optical fiber attachment area by the lid structure.

19. The method as recited in claim 17, further comprising:
attaching a carrier component to a surface of the photonic integrated circuit chip opposite of the optical fiber attachment area; and
attaching the carrier component to a fiber array unit that includes the at least one optical fiber.

20. The method as recited in claim 17, wherein the optical fiber attachment area includes an array of a plurality of V-grooves, wherein the photonic integrated circuit chip includes a plurality of spot size converters, each of the plurality of spot size converters exposed at an interior end of a respective one of the plurality of V-grooves, and wherein disposing the at least one optical fiber within the optical fiber attachment area includes respectively disposing a plurality of optical fibers within the plurality of V-grooves, wherein the method further includes optically aligning a core of each of the plurality of optical fibers with a respective one of the plurality of spot size converters before performing the first solder reflow process to form the first set of soldered connections.
